(19) United States
(12) Patent Application Publication
(10) Pub. No.: US 2026/0366636 A1
(43) Pub. Date: Nov. 19, 2026

(54) VALVE ASSEMBLY, FLOW AMPLIFIER AND FLUID DEVICE

(71) Applicant: Danfoss Power Solutions ApS, Nordborg (DK)

(72) Inventor: Palle OLSEN, Nordborg (DK)

(21) Appl. No.: 19/671,449

(22) Filed: May 8, 2026

(30) Foreign Application Priority Data
May 13, 2025 (CN) 202510612278.2
May 13, 2025 (CN) 202520934621.0

(51) Int. Cl. F16K 17/04; F16K 1/32

(52) U.S. Cl. CPC F16K 17/04; F16K 1/32; F16K 2200/30

(57) ABSTRACT

The present disclosure belongs to the field of fluid control, and specifically relates to a valve assembly, including: an internal assembly; and a fitting assembly, the internal assembly being arranged at a radial inner side of the fitting assembly, the fitting assembly including a first end and a second end in an axial direction, the fitting assembly including a cover portion at the first end, the internal assembly and the cover portion forming a direct-acting anti-cavitation overflow valve, which defines a first region that communicates with a servo side passage and a second region that communicates with an oil tank side passage, the first region being closer to the cover portion compared to the second region, the fitting assembly including a first outer through hole that communicates with the first region and a second outer through hole that communicates with the second region, the first outer through hole being closer to the first end compared to the second outer through hole, and the valve assembly being constructed to be mounted in the fluid device in a direction pointing from the second end to the first end. The valve assembly according to the present disclosure responds more quickly and costs less. The present disclosure further relates to a flow amplifier and a fluid device.

### CROSS-REFERENCE TO RELATED APPLICATIONS

This application claims foreign priority benefits under 35 U.S.C. § 119 to Chinese Application No. 202510612278.2, filed on May 13, 2025, and Chinese Application No. 202520934621.0, filed on May 13, 2025, each of which is hereby incorporated by reference in its entirety.

### TECHNICAL FIELD

The present invention belongs to the field of fluid control, and in particular relates to a valve assembly, a flow amplifier and a fluid device.

### BACKGROUND

In some applications in the field of fluid control, a valve is used to control circulation of fluid. Some valves are used to ensure the normal operation of a related fluid device. For example, an overflow valve is used for restricting pressure intensity of fluid in a device, preventing system overload. For example, an anti-cavitation valve is used for preventing cavitation from occurring in a fluid passage, generating noise and damaging parts.

In some fluid devices, a combined valve structure is used to execute multiple functions by means of a single assembly or a product. For example, two pilot anti-cavitation overflow valves are provided in some fluid amplifiers used for a steering function, and realize pressure intensity control and anti-cavitation effects at a fluid passage that passes into an oil cylinder that controls left steering and a fluid passage that passes into an oil cylinder that controls right steering, respectively.

However, the internal structure of the pilot anti-cavitation overflow valve is more complicated, and the response thereof for a corresponding scenario is slower, and a fluid device fitted with a pilot anti-cavitation overflow valve is expensive. In another aspect, the respective structures of current pilot anti-cavitation overflow valves and corresponding fluid devices are already designed to be adapted to each other as well as highly compact, and consequently it is difficult to further improve the structure of the pilot anti-cavitation overflow valve or fluid device.

Therefore, a technical solution that is at least able to solve some of the above problems is desirable.

### SUMMARY

Regarding the above problems, a first aspect according to the present invention proposes a valve assembly, used for a fluid device, the valve assembly comprising: an internal assembly, which defines an axial direction; and a fitting assembly, the internal assembly being arranged at a radial inner side of the fitting assembly, the fitting assembly comprising a first end and a second end opposite the first end in an axial direction, the fitting assembly comprising a cover portion at the first end, and the internal assembly and the cover portion forming a direct-acting anti-cavitation overflow valve, wherein the direct-acting anti-cavitation overflow valve defines a first region that is constructed to be in fluid communication with a servo side passage of the fluid device and a second region that is constructed to be in fluid communication with an oil tank side passage of the fluid device, the first region being closer to the cover portion compared to the second region in the axial direction, wherein the fitting assembly comprises at least one first outer through hole and at least one second outer through hole, the first outer through hole being in fluid communication with the first region and being open at an outer surface of the fitting assembly, the second outer through hole being in fluid communication with the second region and being open at an outer surface of the fitting assembly, and the first outer through hole being closer to the first end of the fitting assembly compared to the second outer through hole in the axial direction, wherein an outer shape of the fitting assembly is constructed such that the valve assembly is suitable for being mounted in the fluid device in a direction pointing from the second end to the first end.

The valve assembly according to the first aspect of the present invention is internally provided with a direct-acting anti-cavitation overflow valve structure. The valve assembly is configured such that the first outer through hole and the first region in fluid communication with the servo side are closer to the first end, and the second outer through hole and the second region in fluid communication with the oil tank side are closer to the second end. In addition, the outer shape of the fitting assembly is constructed such that the valve assembly is suitable for being mounted in the fluid device in a direction from the second end to the first end. Thus, the valve assembly according to the first aspect of the present invention can be mounted in the main body of a fluid device (such as a flow amplifier) constructed to use a pilot anti-cavitation overflow valve, and it is not necessary to change the main body structure of the fluid device. Since the direct-acting anti-cavitation overflow valve responds faster to a corresponding scenario compared to the pilot anti-cavitation overflow valve, and the structure is simpler, and the manufacturing cost is lower, according to the first aspect of the present invention, the valve assembly can be mounted in the main body of a fluid device constructed to use a pilot anti-cavitation overflow valve, thereby manufacturing a fluid device that responds faster at a lower cost.

The valve assembly according to the present invention may have one or more of the following features, alone or in combination.

According to an embodiment, preferably, a radial outer dimension of the fitting assembly reduces or substantially does not change from the second end to the first end in the axial direction. A valve assembly according to this embodiment has a simpler outer shape and can adapt to various fluid devices.

According to an embodiment, preferably, the fitting assembly comprises a sleeve that extends longitudinally in the axial direction, the sleeve defining a radial outer portion of the fitting assembly in at least a portion of an axial extension range of the fitting assembly. An outer structure of a valve assembly according to this embodiment is sturdy and can simplify a process of mounting in a fluid device.

According to an embodiment, preferably, the internal assembly is arranged at a radial inner side of the sleeve, and the sleeve comprises a sleeve axial end that is located at the first end of the fitting assembly, the sleeve axial end defining the cover portion, and the first outer through hole and the second outer through hole being arranged on the sleeve. A valve assembly according to this embodiment has fewer parts, and the manufacturing cost is lower.

According to an embodiment, preferably, the fitting assembly further comprises a first valve seat, the first valve seat being fixed to the radial inner side of the sleeve, and the internal assembly being arranged between the first valve seat and the cover portion. A valve assembly according to this embodiment has a simpler assembly process.

According to an embodiment, preferably, the fitting assembly comprises a tubular member arranged at a radial inner side of the sleeve, the internal assembly being arranged at a radial inner side of the tubular member, and the tubular member comprising a tubular member axial end that is located at the first end of the fitting assembly, the tubular member axial end defining the cover portion, the first outer through hole being arranged on the tubular member, and the second outer through hole being arranged on the sleeve. A valve assembly according to this embodiment has a simpler assembly process, and additionally enables specific dimensions of the tubular member to be set according to the specification of the required direct-acting anti-cavitation overflow valve.

According to an embodiment, preferably, at least one first anti-cavitation through hole and at least one second anti-cavitation through hole are provided on the sleeve, a fluid passage that connects the first anti-cavitation through hole and the second anti-cavitation through hole being defined between a radial outer surface of the tubular member and a radial inner surface of the sleeve, and the tubular member being able to open or close the fluid passage by moving in the axial direction, wherein the fitting assembly is constructed such that in a scenario in which a pressure intensity of fluid at the second region does not exceed an oil tank side pressure intensity, the tubular member closes the fluid passage, and, in a scenario in which the pressure intensity of fluid at the second region exceeds the oil tank side pressure intensity, the tubular member opens the fluid passage by moving in a direction that points from the second end to the first end. A valve assembly according to this embodiment has an improved anti-cavitation effect.

According to an embodiment, preferably, the second anti-cavitation through hole is closer to the first end of the fitting assembly compared to the second outer through hole in the axial direction. A valve assembly according to this embodiment has a further improved anti-cavitation effect.

According to an embodiment, preferably, the fitting assembly comprises an anti-cavitation spring, the anti-cavitation spring being constructed such that the tubular member is offset in the direction pointing from the first end to the second end.

According to an embodiment, preferably, the anti-cavitation spring is a helical spring, the anti-cavitation spring being wound on the radial outer surface of the tubular member and being located between the radial outer surface of the tubular member and the radial inner surface of the sleeve. A valve assembly according to this embodiment has an improved anti-cavitation effect, and an anti-cavitation function operates more stably.

According to an embodiment, preferably, the anti-cavitation spring is a helical spring, and the anti-cavitation spring is arranged on an outer side of the tubular member axial end in the axial direction. A valve assembly according to this embodiment has an improved anti-cavitation effect, the parts thereof have a simple structure, and a greater tolerance is allowed.

According to an embodiment, preferably, the fluid device is a flow amplifier, and the first outer through hole passes into the servo side passage of the flow amplifier at an outer surface of the fitting assembly, and the second outer through hole passes into the oil tank side passage of the flow amplifier at the outer surface of the fitting assembly.

According to a second aspect of the present invention, a flow amplifier is proposed, the flow amplifier comprising one or more of any one of the valve assemblies mentioned above.

The fluid amplifier according to the second aspect of the present invention has the corresponding advantages of the valve assembly mentioned above.

According to a third aspect of the present invention, a fluid device is proposed, the fluid device comprising one or more of any one of the valve assemblies mentioned above.

The fluid device according to the third aspect of the present invention has the corresponding advantages of the valve assembly mentioned above.

### BRIEF DESCRIPTION OF THE DRAWINGS

To more clearly explain the technical solutions of the embodiments of the present invention, the accompanying drawings of the embodiments of the present invention are briefly described below. The accompanying drawings are merely for illustrating certain embodiments of the present invention, rather than restricting all embodiments of the present invention thereto.

FIG. 1A is a cross-sectional drawing of an example of a flow amplifier fitted with a pilot anti-cavitation overflow valve.

FIG. 1B is a cross-sectional drawing of an internal assembly of a valve assembly according to embodiments of the present invention.

FIG. 2A is a cross-sectional drawing of a valve assembly according to a first embodiment of the present invention.

FIG. 2B is a partial sectional drawing of a flow amplifier fitted with the valve assembly according to the first embodiment of the present invention.

FIG. 3A is a cross-sectional drawing of a valve assembly according to a second embodiment of the present invention.

FIG. 3B is a partial sectional drawing of a flow amplifier fitted with the valve assembly according to the second embodiment of the present invention.

FIG. 3C is another partial sectional drawing of the flow amplifier fitted with the valve assembly according to the second embodiment of the present invention.

FIG. 4A is a cross-sectional drawing of a valve assembly according to a third embodiment of the present invention.

FIG. 4B is a partial sectional drawing of a flow amplifier fitted with the valve assembly according to the third embodiment of the present invention.

### DETAILED DESCRIPTION

In order to clarify the objectives of the technical solutions, the technical solutions and the advantages of the present invention, the technical solutions of the embodiments of the present invention are described clearly and completely below with reference to the drawings of the particular embodiments of the present invention. Identical reference labels in the drawings represent identical components. It must be explained that the embodiments described are some, not all, of the embodiments of the present invention. All other embodiments obtained by those skilled in the art on the basis of the described embodiments of the present invention without inventive effort shall be included in the scope of protection of the present invention.

Unless otherwise defined, the technical terms or scientific terms used herein shall have the common meanings as understood by a person of ordinary skill in the field of the present invention. The terms “first”, “second” and similar terms used in the description and claims of the patent application for the present invention do not indicate any order, quantity or importance, but rather are only used to distinguish different constituent parts. Similarly, terms such as “one” or “a” also do not necessarily indicate a quantity restriction. Terms such as “comprise” or “include” mean that an element or item appearing before this term encompasses elements or items and equivalents thereof that appear listed after this term, but does not exclude other elements or items. Terms such as “connect” or “interconnect” are not limited to direct connection, but also may comprise indirect connection. Terms such as “upper”, “lower”, “left” and “right” are only used for indicating a relative positional relationship; when the absolute position of a described object changes, then this relative positional relationship also may change correspondingly.

The present invention is described in detail below by way of describing exemplary embodiments.

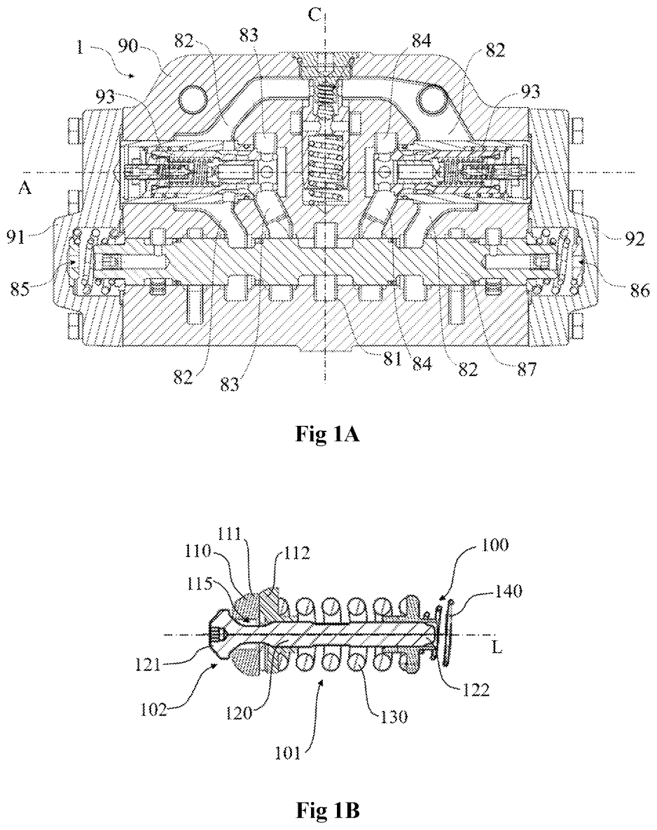

FIG. 1A is a cross-sectional drawing of an example of a flow amplifier fitted with a pilot anti-cavitation overflow valve. The cross-sectional drawing shows a valve core 87 of a flow amplifier, the valve core 87 being configured to move in a valve hole under the drive of a first driving mechanism 85 and a second driving mechanism 86, thereby controlling a circulation relationship between a pump passage 81, an oil tank side passage 82, a first servo side passage 83 and a second servo side passage 84. In FIG. 1A, the first servo side passage 83 may be in fluid communication with a first side (not shown) of an oil cylinder, and the second servo side passage 84 may be in fluid communication with a second side (not shown) of the oil cylinder. Thus, the flow amplifier shown in FIG. 1A can have a flow amplification function, and the specific working mechanism thereof is not detailed here.

The flow amplifier shown in FIG. 1A is provided with two pilot anti-cavitation overflow valves 93. The two pilot anti-cavitation overflow valves 93 are substantially symmetrically arranged relative to a central plane C, each pilot anti-cavitation overflow valve 93 being respectively arranged in a corresponding valve receiving part of the flow amplifier. In FIG. 1A, a valve receiving part is connected between the oil tank side passage 82 and the first servo side passage 83, and another valve receiving part is connected between the oil side passage 82 and the second servo side passage 84.

The flow amplifier shown in FIG. 1A comprises a first side component 91 and a second side component 92 that are respectively fixed to a middle component 90 from two sides and define the middle component 90 of said each fluid passage. When assembling the flow amplifier, the pilot anti-cavitation overflow valve 93 located on the left in FIG. 1A moves from the left of the middle component 90 along an axis A toward the right and enters the corresponding valve receiving part, and the pilot anti-cavitation overflow valve 93 located on the right in FIG. 1A moves from the right of the middle component 90 along the axis A toward the left and enters the corresponding valve receiving part, and the first side component 91 and the second side component 92 are further fixed to the middle component 90 after being mounted on the corresponding valve receiving part of the two pilot anti-cavitation overflow valves 93. It can be seen from FIG. 1A that an internal structure of the middle component 90 of the flow amplifier is constructed to match the shape and mounting path of the pilot anti-cavitation overflow valve 93.

For example, a radial outer dimension of the pilot anti-cavitation overflow valve 93 on the left in FIG. 1A reduces or substantially does not change along the axis A in a direction from an outer side (the left side in FIG. 1A) of the middle component 90 to the central plane C. Correspondingly, a radial inner dimension of the valve receiving part on the left in FIG. 1A reduces or substantially does not change along the axis A in the direction from the outer side of the middle component 90 to the central plane C. Thus, the pilot anti-cavitation overflow valve 93 can only enter and be mounted in the valve receiving part by moving from the outer side of the middle component 90. In this case, a radial dimension of the valve receiving part or the pilot anti-cavitation overflow valve 93 reducing or substantially not changing may comprise the following scenario: a radial outer dimension of the pilot anti-cavitation overflow valve 93 and a radial inner dimension of the valve receiving part along the axis A reducing or substantially not changing in subsections. For example, in a scenario in which the shape of the valve receiving part is in the shape of multiple cylinders arranged axially along the axis A, the radial inner dimension of the valve receiving part is a corresponding diameter of the multiple cylinders.

FIG. 1B shows a cross-sectional drawing of an internal assembly 100 of a valve assembly 10 according to embodiments of the present invention. The internal assembly 100 forms a portion of a direct-acting anti-cavitation overflow valve. As shown in FIG. 1B, the internal assembly comprises an internal valve seat 110, a rod 120, a first spring 130 and a second spring 140. The internal valve seat 110 comprises a central through hole 115; the rod 120 movably passes through the central through hole 115 of the internal valve seat, and a first end 121 and a second end 122 of the rod 120 are respectively located at two opposite sides of the internal valve seat 110. As shown in FIG. 1B, the internal valve seat 110 may comprise a first portion 111 and a second portion 112 that are arranged in an extension direction of the rod 120. In a scenario in which the internal assembly 100 is mounted in a corresponding accommodating part thereof, the first portion 111 and the second portion 112 are fixed to each other. However, the first portion 111 and the second portion 112 may be separable from each other to facilitate manufacture of parts. In other embodiments, the first portion 111 and the second portion 112 may also be formed as an integral component.

As shown in FIG. 1B, the first spring 130 is arranged between the second end 122 of the rod and the internal valve seat 110. In FIG. 1B, the first spring 130 is configured to offset the rod 120 to the right, so that the first end 121 of the rod abuts a left portion of the central through hole 115 and fluid-seals the central through hole 115. The second spring 140 is arranged on one side of the second end 122 of the rod that is remote from the internal valve seat 110. In FIG. 1B, the second spring 140 offsets the internal valve seat 110 to the left via the second end 122 of the rod and the first spring 130, so that the internal valve seat 110 abuts a right portion of a through hole that is not shown and fluid-seals this through hole that is not shown. In a scenario in which a cover component is arranged at one end of the second spring 140 that is remote from the rod 120, the internal assembly 100 and the cover component may form a direct-acting anti-cavitation overflow valve. Correspondingly, the internal assembly 100 may define an axial direction L, as shown in FIG. 1B.

In a scenario in which the internal assembly 100 is mounted in the corresponding accommodating part to form a direct-acting anti-cavitation overflow valve, a region that is near the first spring 130 is configured to be in fluid communication with a servo side of a fluid device (for example connected to an oil cylinder), and a region that is near the internal valve seat 110 and faces away from the second spring 140 (i.e. a portion of a left region of the internal valve seat 110 in FIG. 1B) is configured to be in fluid communication with an oil tank side of the fluid device. According to the present invention, the direct-acting anti-cavitation overflow valve defines a first region 101 that is in fluid communication with a servo side passage of the fluid device and a second region 102 that is in fluid communication with an oil tank side passage of the fluid device. FIG. 1B schematically shows the first region 101 and the second region 102.

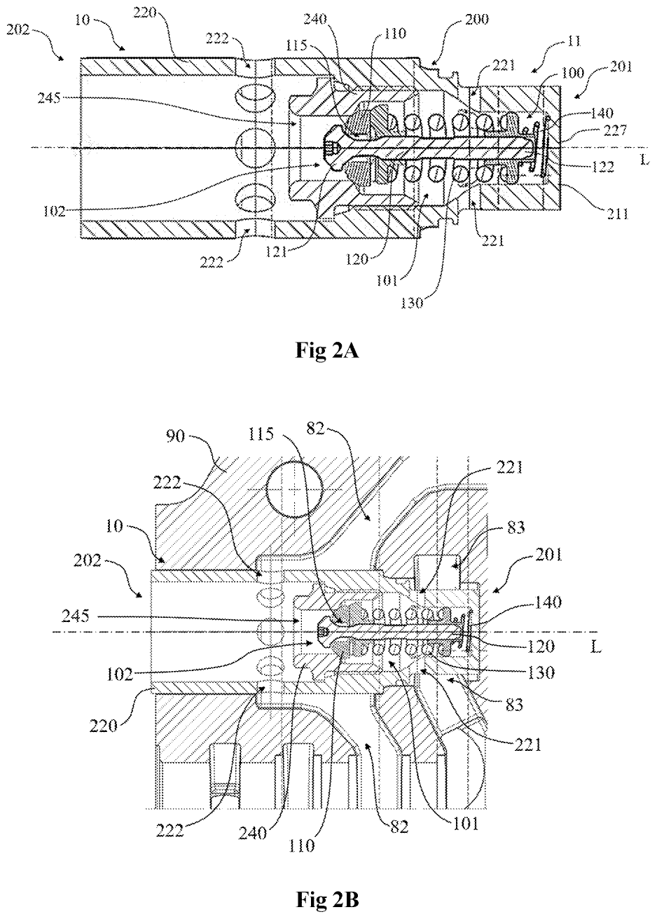

FIG. 2A shows a cross-sectional drawing of a valve assembly 10 according to a first embodiment of the present invention. As shown in FIG. 2A, the valve assembly 10 comprises the internal assembly 100 shown in FIG. 1B, and further comprises a fitting assembly 200, the internal assembly 100 being arranged at a radial inner side of the fitting assembly 200. Specifically, the fitting assembly 200 comprises a sleeve 220 that extends longitudinally in an axial direction L, the sleeve 220 defining a radial outer portion of the fitting assembly 200 in an axial extension range of the fitting assembly 200, and the internal assembly 100 being arranged at a radial inner side of the sleeve 220.

In FIG. 2A, the fitting assembly 200 comprises a first end 201 and a second end 202 that is opposite the first end 201 in the axial direction. The first end 201 of the fitting assembly 200 comprises a cover portion 211. Specifically, the sleeve 220 comprises a sleeve axial end 227 that is located at the first end 201 of the fitting assembly 200, this sleeve axial end 227 defining a cover portion 211. The cover portion 211 is located at an end of the second spring 140 that is remote from the rod 120, so that this end of the second spring 140 can abut the cover portion 211 and be compressed. Thus, the internal assembly 100 and the cover portion 211 form a direct-acting anti-cavitation overflow valve 11. FIG. 2A specifically shows a first region 101 and a second region 102 of the direct-acting anti-cavitation overflow valve; as shown in FIG. 2A, the first region 101 is closer to the cover portion 211 compared to the second region 102.

FIG. 2A further shows a first valve seat 240 of the fitting assembly 200. The first valve seat 240 is fixed at a radial inner side of the sleeve 220, and comprises a central through hole 245 that is penetrating in the axial direction L. The internal assembly 100 is arranged between the first valve seat 240 and the cover portion 211. The internal valve seat 110 of the internal assembly 100 can abut the first valve seat 240 to seal the central through hole 245.

Further referring to FIG. 2A, multiple first outer through holes 221 and multiple second outer through holes 222 are provided on the sleeve 220. The first outer through hole 221 is in fluid communication with the first region 101 and is open at an outer surface of the sleeve 220, i.e. open at an outer surface of the fitting assembly 200. The second outer through hole 222 is in fluid communication with the second region 102 and is open at the outer surface of the sleeve 220, i.e. open at the outer surface of the fitting assembly 200. As shown in FIG. 2A, the first outer through hole 221 is closer to the first end 201 of the fitting assembly 200 compared to the second outer through hole 222 in the axial direction L. It should be pointed out that, according to the present invention, the specific quantities of the first outer through hole 221 and the second outer through hole 222 are not restricted.

FIG. 2B shows a partial sectional drawing of a flow amplifier, wherein the valve assembly 10 shown in FIG. 2A is mounted in a valve receiving part that is constructed to receive a pilot anti-cavitation overflow valve. It can be seen from FIG. 2B that the first outer through hole 221 puts the first region 101 in fluid communication with a servo side passage (e.g. a first servo side passage 83), and the second outer through hole 222 puts the second region 102 in fluid communication with an oil tank side passage 82.

When a pressure intensity of fluid in the servo side passage 83 is not greater than a servo side pressure intensity threshold value, the rod 120 is acted on by the first spring 130 and abuts and seals the central through hole 115 on the internal valve seat 110. When the pressure intensity of fluid in the servo side passage 83 is greater than the servo side pressure intensity threshold value, fluid in the first region 101 pushes the rod 120 to move left to open the central through hole 115 on the internal valve seat 110, and the first region 101 is in fluid communication with the second region 102, until the pressure intensity of fluid in the servo side passage 83 is no longer greater than the servo side pressure intensity threshold value. In addition, when a pressure intensity of fluid in the oil tank side passage 82 is not greater than an oil tank side pressure intensity, the internal valve seat 110 is acted on by the second spring 140 and abuts and seals a central through hole 245 on the first valve seat 240. When the pressure intensity of fluid in the oil tank side passage 82 is greater than the oil tank side pressure intensity, fluid in the second region 102 pushes the internal valve seat 110 to move right to open the central through hole 245 on the first valve seat 240, and the second region 102 is in fluid communication with the first region 101, until the pressure intensity of fluid in the oil tank side passage 82 is no longer greater than the oil tank side pressure intensity.

According to the present invention, the outer shape of the fitting assembly 200 is constructed such that the valve assembly 10 is suitable for being mounted in the fluid device in a direction pointing from the second end 202 to the first end 201. For example, as shown in the embodiment of FIGS. 2A and 2B, a radial outer dimension of the fitting assembly 200 reduces or substantially does not change in the axial direction L from the second end 202 to the first end 201. Thus, the valve assembly 10 can be loaded in the direction from the second end 202 to the first end 201 along the axial direction L into the corresponding valve receiving part of the fluid device, e.g. being loaded into the valve receiving part of the middle component 90 of the flow amplifier, without needing to alter the internal structure that already has the middle component 90.

In this case, the radial outer dimension of the fitting assembly 200 reducing or substantially not changing in the axial direction L may correspond to the following scenario: the radial outer dimension of the fitting assembly 200 reducing or substantially not changing in subsections in the axial direction L. In this case, the radial outer dimension that substantially does not change may correspond to the following scenario: the radial outer dimension of the fitting assembly 200 may change slightly in the axial direction, for example, due to a tolerance or an O-ring, and the valve assembly 10 can still move in the direction pointing from the second end 202 to the first end 201 and be mounted in the fluid device.

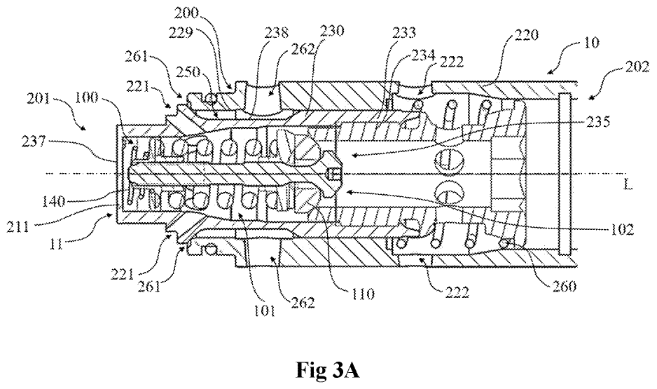

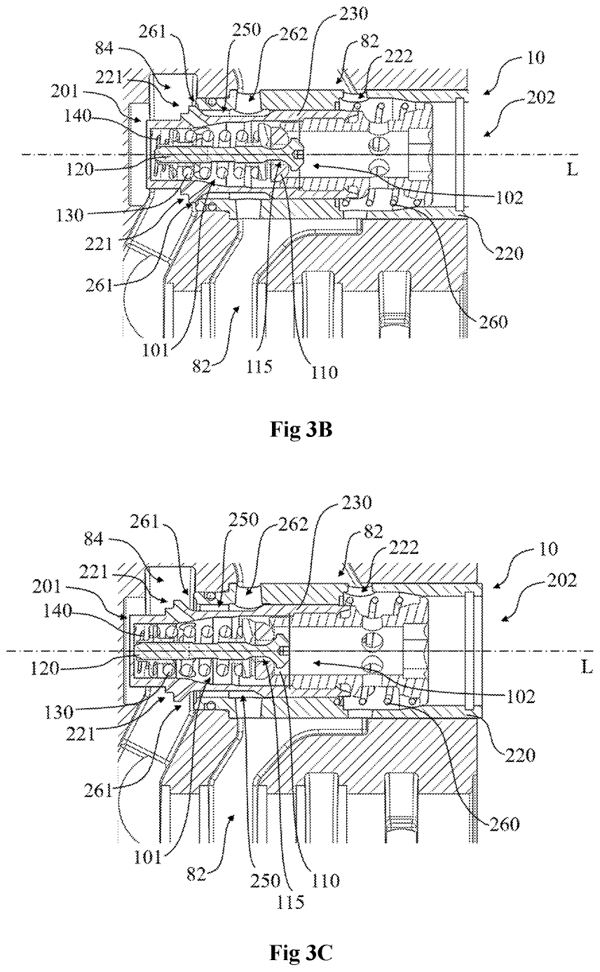

FIG. 3A shows a cross-sectional drawing of a valve assembly 10 according to a second embodiment of the present invention. As shown in FIG. 3A, a valve assembly 10 comprises the internal assembly 100 shown in FIG. 1B, and further comprises a fitting assembly 200, the internal assembly 100 being arranged at a radial inner side of the fitting assembly 200. Specifically, the fitting assembly 200 comprises a sleeve 220 that extends longitudinally in an axial direction L and a tubular member 230 that is arranged at a radial inner side of the sleeve 220, the internal assembly 100 being arranged at the radial inner side of the tubular member 230. A portion of the sleeve 220 in an axial extension range of the fitting assembly 200 defines a radial outer portion of the fitting assembly 200.

In FIG. 3A, the fitting assembly 200 comprises a first end 201 and a second end 202 opposite the first end 201 in an axial direction. The fitting assembly 200 comprises a cover portion 211 at the first end 201. Specifically, the tubular member 230 comprises a tubular member axial end 237 located at the first end 201 of the fitting assembly 200, the tubular member axial end 237 defining the cover portion 211. The cover portion 211 is located at an end of the second spring 140 that is remote from the rod 120, so that this end of the second spring 140 can abut the cover portion 211 and be compressed. Thus, the internal assembly 100 and the cover portion 211 form a direct-acting anti-cavitation overflow valve 11. FIG. 3A specifically shows a first region 101 and a second region 102 of a direct-acting anti-cavitation overflow valve, the first region 101 being closer to the cover portion 211 compared to the second region 102.

As shown in FIG. 3A, multiple first outer through holes 221 are provided on the tubular member 230, and multiple second outer through holes 222 are provided on the sleeve 220. Specifically, a tubular member main body 233 and a second valve seat 234 are fitted to each other to form the tubular member 230. The multiple first outer through holes 221 are arranged on the tubular member main body 233. The second valve seat 234 comprises a central through hole 235 that is penetrating in an axial direction L. The internal valve seat 110 of the internal assembly 100 can abut the second valve seat 234 to seal the central through hole 235. The first outer through hole 221 is in fluid communication with the first region 101 and is open at an outer surface of the fitting assembly 200. The second outer through hole 222 is in fluid communication with the second region 102 via the second valve seat 234 and is open at an outer surface of the sleeve 220, i.e. open at an outer surface of the fitting assembly 200. As shown in FIG. 3A, the first outer through hole 221 is closer to the first end 201 of the fitting assembly 200 compared to the second outer through hole 222 in the axial direction L. It should be pointed out that, according to the present invention, the specific quantities of the first outer through hole 221 and the second outer through hole 222 are not restricted.

Further referring to FIG. 3A, a first anti-cavitation through hole 261 and a second anti-cavitation through hole 262 are provided on the sleeve 220, and a fluid passage 250 is defined between a radial outer surface 238 of the tubular member 230 and a radial inner surface of the sleeve 220, this fluid passage 250 connecting the first anti-cavitation through hole 261 and the second anti-cavitation through hole 262. For example, as shown in FIG. 3A, an axial end portion of the sleeve 220 is penetrating in the axial direction L to form the first anti-cavitation through hole 261, and the second anti-cavitation through hole 262 is located between the first anti-cavitation through hole 261 and the second outer through hole 222 in the axial direction L; in other words, the second anti-cavitation through hole 262 is closer to the first end 201 of the fitting assembly 200 compared to the second outer through hole 222 in the axial direction L. According to the present invention, in a scenario in which the valve assembly 10 is mounted in the fluid device, the first anti-cavitation through hole 261 is constructed to be in fluid communication with a servo side of the fluid device, and the second anti-cavitation through hole 262 is constructed to communicate with an oil tank side of the fluid device.

According to the present invention, the tubular member 230 can move in the sleeve 220 in the axial direction L to open or close the fluid passage 250. When the fluid passage 250 is closed (see FIG. 3A and FIG. 3B), the servo side of the fluid device and the oil tank side of the fluid device do not communicate with each other via the fluid passage 250. When the fluid passage 250 is open (see FIG. 3C), the servo side of the fluid device and the oil tank side of the fluid device communicate with each other via the fluid passage 250.

Further referring to FIG. 3A, the fitting assembly 200 further comprises an anti-cavitation spring 260. The anti-cavitation spring 260 is a helical spring, which is wound on the radial outer surface 238 of the tubular member 230. The anti-cavitation spring 260 is located between the radial outer surface 238 of the tubular member and the radial inner surface 229 of the sleeve, to apply an opposing force to the tubular member 230 and the sleeve 220 along the axial direction. Specifically, the anti-cavitation spring 260 offsets the tubular member 230 in a direction pointing from the first end 201 to the second end 202, to cause the tubular member 230 to close the fluid passage 250.

FIGS. 3B and 3C respectively show a partial sectional drawing of a flow amplifier, wherein the valve assembly 10 shown in FIG. 3A is mounted in a valve receiving part that is constructed for receiving a pilot anti-cavitation overflow valve. It can be seen from FIG. 3B that the first outer through hole 221 puts the first region 101 in fluid communication with a servo side passage (e.g. a second servo side passage 84), and the second outer through hole 222 puts the second region 102 in fluid communication with an oil tank side passage 82. In addition, the first anti-cavitation through hole 261 is in fluid communication with the servo side passage, and the second anti-cavitation through hole 262 is in fluid communication with the oil tank side passage.

According to this second embodiment of the present invention, in FIGS. 3B and 3C, when a pressure intensity of fluid in the servo side passage 84 is not greater than a servo side pressure intensity threshold value, the rod 120 is acted on by the first spring 130 and abuts and seals a central through hole 115 on the internal valve seat 110. When the pressure intensity of fluid in the servo side passage 84 is greater than the servo side pressure intensity threshold value, fluid in the first region 101 pushes the rod 120 to move right to open the central through hole 115 on the internal valve seat 110, and the first region 101 is in fluid communication with the second region 102, until the pressure intensity of fluid in the servo side passage 84 is no longer greater than the servo side pressure intensity threshold value.

According to this second embodiment of the present invention, when a pressure intensity of fluid in the oil tank side passage 82 is not greater than an oil tank side pressure intensity, a pressure intensity of fluid at the second region 102 does not exceed the oil tank side pressure intensity. In such a scenario, as shown in FIG. 3B, in one aspect, the internal valve seat 110 is acted on by the second spring 140 and abuts and seals the central through hole 235 on the second valve seat 234, and, in another aspect, the anti-cavitation spring 260 offsets the tubular member 230 to close the fluid passage 250. When the pressure intensity of fluid in the oil tank side passage 82 is greater than the oil tank side pressure intensity, the pressure intensity of fluid at the second region 102 also exceeds the oil tank side pressure intensity; as shown in FIG. 3C, in one aspect, fluid in the second region 102 pushes the internal valve seat 110 to move left to open the central through hole 235 on the second valve seat 234, and, in another aspect, fluid in the second region 102 and in a space in fluid communication with the second region 102 pushes the overall tubular member 230 to move in the direction pointing from the second end 202 to the first end 201 (i.e. moving toward the left in FIGS. 3B and 3C) to open the fluid passage 250. Thus, the oil tank side passage is in fluid communication with the servo side passage, until the pressure intensity of fluid in the oil tank side passage 82 is no longer greater than the oil tank side pressure intensity.

According to the present invention, since the fluid passage 250 is arranged between the radial outer surface 238 of the tubular member 230 and the radial inner surface 229 of the sleeve 220, fluid flow for anti-cavitation is increased, and the valve assembly 10 has an improved anti-cavitation effect. According to the second embodiment of the present invention, in a scenario in which the second anti-cavitation through hole 262 is located between the first anti-cavitation through hole 261 and the second outer through hole 222 in the axial direction L, the length of a fluid path of the fluid passage 250 is reduced, and fluid flow resistance is reduced, obtaining a further improved anti-cavitation effect.

Simultaneously referring to FIGS. 3A, 3B and 3C, the outer shape of the fitting assembly 200 is constructed such that the valve assembly 10 is suitable for being mounted in the fluid device in the direction pointing from the second end 202 to the first end 201. Specifically, a radial outer dimension of the fitting assembly 200 reduces or substantially does not change in the axial direction L from the second end 202 to the first end 201. Thus, the valve assembly 10 can be loaded in the direction from the second end 202 to the first end 201 along the axial direction L into the corresponding valve receiving part of the fluid device, e.g. being loaded into the valve receiving part of the middle component 90 of the flow amplifier, without needing to alter the internal structure that already has the middle component 90.

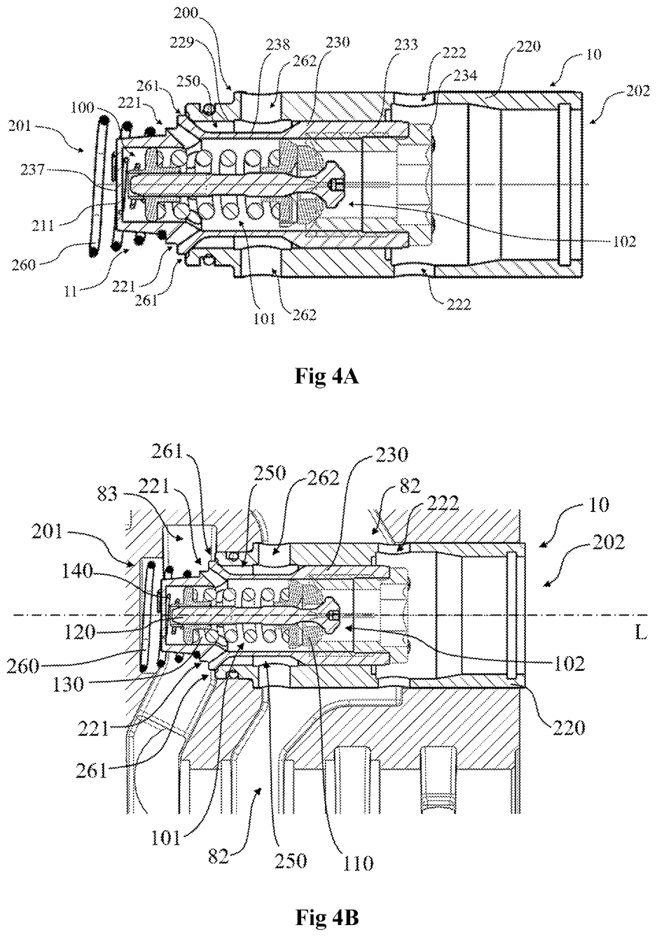

FIG. 4A shows a cross-sectional drawing of a valve assembly 10 according to a third embodiment of the present invention. As shown in FIG. 4A, the valve assembly 10 comprises the internal assembly 100 as shown in FIG. 1B, and further comprises a fitting assembly 200, the internal assembly 100 being arranged at the radial inner side of the fitting assembly 200. The fitting assembly 200 comprises a sleeve 220 that extends longitudinally in an axial direction L and a tubular member 230 that is arranged at a radial inner side of the sleeve 220, the internal assembly 100 being arranged at a radial inner side of the tubular member 230. A portion of the sleeve 220 in an axial extension range of the fitting assembly 200 defines a radial outer portion of the fitting assembly 200.

The internal assembly 100 and the sleeve 220 shown in FIG. 4A respectively have the same structures as the internal assembly and the sleeve 220 shown in FIG. 3A, which are not detailed again here. The tubular member 230 shown in FIG. 4A has substantially the same structure as the tubular member 230 and a fitting relationship with the internal assembly 100 and the sleeve 220 shown in FIG. 3A; below, only the points of difference to the valve assembly 10 shown in FIG. 4A and the valve assembly 10 shown in FIG. 3A are detailed.

As shown in FIG. 4A, the fitting assembly 200 comprises an anti-cavitation spring 260. The anti-cavitation spring 260 is a helical spring, which is arranged at an outer side of an axial end 237 of the tubular member 230 in the axial direction L, and therefore a spring no longer needs to be provided between the radial outer surface 238 of the tubular member and the radial inner surface 229 of the sleeve. Also referring to FIG. 4B, in a scenario in which the valve assembly 10 is mounted in the fluid device, the anti-cavitation spring 260 is located between the axial end 237 of the tubular member 230 and an inner wall of the valve receiving part of the fluid device. Thus, the anti-cavitation spring 260 is constructed such that the tubular member 230 is offset in the direction pointing from the first end 201 to the second end 202, to cause the tubular member 230 to close the fluid passage 250.

FIG. 4B shows a partial sectional drawing of a flow amplifier. The valve assembly 10 shown in FIG. 4A is mounted in the valve receiving part of the flow amplifier constructed to receive a pilot anti-cavitation overflow valve. It can be seen that the valve assembly 10 shown in FIGS. 4A and 4B can have an identical anti-overflow function and a similar improved anti-cavitation effect to the valve assembly 10 shown in FIGS. 3A to 3C.

Simultaneously referring to FIGS. 4A and 4B, the outer shape of the fitting assembly 200 is constructed such that the valve assembly 10 is suitable for being mounted in the fluid device in a direction from the second end 202 to the first end 201. Specifically, a radial outer dimension of the fitting assembly 200 reduces or substantially does not change in the axial direction L from the second end 202 to the first end 201. Thus, the valve assembly 10 can be loaded in the direction from the second end 202 to the first end 201 along the axial direction L into the corresponding valve receiving part of the fluid device, e.g. being loaded into the valve receiving part of the middle component 90 of the flow amplifier, without needing to alter the internal structure that already has the middle component 90.

The valve assembly 10 of each embodiment mentioned above can be easily mounted in various fluid devices, for example for replacing a pilot anti-cavitation overflow valve. The fluid device, for example, may be a flow amplifier; in such a scenario, two valve assemblies 10 of identical structures may be symmetrically arranged, so that the flow amplifier has a faster response speed and a lower manufacturing cost.

The above describes exemplary embodiments of a valve assembly, a flow amplifier and a fluid device proposed by the present invention in detail with reference to preferred embodiments. However, a person skilled in the art will understand that various modifications and changes may be made to the above particular embodiments without departing from the concept of the present invention, and the various technical features and structures proposed by the present invention may be combined in various ways, which does not exceed the scope of protection of the present invention.

What is claimed is:

1. A valve assembly, used for a fluid device, wherein the valve assembly comprises:
an internal assembly, which defines an axial direction (L); and
a fitting assembly, the internal assembly being arranged at a radial inner side of the fitting assembly, the fitting assembly comprising a first end and a second end opposite the first end in an axial direction, the fitting assembly comprising a cover portion at the first end, and the internal assembly and the cover portion forming a direct-acting anti-cavitation overflow valve, wherein the direct-acting anti-cavitation overflow valve defines a first region that is constructed to be in fluid communication with a first fluid passage of the fluid device and a second region that is constructed to be in fluid communication with a second fluid passage of the fluid device, the first region being closer to the cover portion compared to the second region in the axial direction (L),
wherein the fitting assembly comprises at least one first outer through hole and at least one second outer through hole, the first outer through hole being in fluid communication with the first region and being open at an outer surface of the fitting assembly, the second outer through hole being in fluid communication with the second region and being open at an outer surface of the fitting assembly, and the first outer through hole being closer to the first end of the fitting assembly compared to the second outer through hole in the axial direction (L),
wherein an outer shape of the fitting assembly is constructed such that the valve assembly is suitable for being mounted in the fluid device in a direction pointing from the second end to the first end.

2. The valve assembly according to claim 1, wherein
a radial outer dimension of the fitting assembly reduces or substantially does not change from the second end to the first end in the axial direction (L).

3. The valve assembly according to claim 1, wherein
the fitting assembly comprises a sleeve that extends longitudinally in the axial direction (L), the sleeve defining a radial outer portion of the fitting assembly in at least a portion of an axial extension range of the fitting assembly.

4. The valve assembly according to claim 3, wherein
the internal assembly is arranged at a radial inner side of the sleeve, and the sleeve comprises a sleeve axial end that is located at the first end of the fitting assembly, the sleeve axial end defining the cover portion, and the first outer through hole and the second outer through hole being arranged on the sleeve.

5. The valve assembly according to claim 4, wherein
the fitting assembly further comprises a first valve seat, the first valve seat being fixed to the radial inner side of the sleeve, and the internal assembly being arranged between the first valve seat and the cover portion.

6. The valve assembly according to claim 3, wherein
the fitting assembly comprises a tubular member arranged at a radial inner side of the sleeve, the internal assembly being arranged at a radial inner side of the tubular member, and the tubular member comprising a tubular member axial end that is located at the first end of the fitting assembly, the tubular member axial end defining the cover portion, the first outer through hole being arranged on the tubular member, and the second outer through hole being arranged on the sleeve.

7. The valve assembly according to claim 6, wherein
at least one first anti-cavitation through hole and at least one second anti-cavitation through hole are provided on the sleeve, a fluid passage that connects the first anti-cavitation through hole and the second anti-cavitation through hole being defined between a radial outer surface of the tubular member and a radial inner surface of the sleeve, and the tubular member being able to open or close the fluid passage by moving in the axial direction (L),
wherein the fitting assembly is constructed such that in a scenario in which a pressure intensity of fluid at the second region does not exceed an oil tank side pressure intensity, the tubular member closes the fluid passage, and, in a scenario in which the pressure intensity of fluid at the second region exceeds the oil tank side pressure intensity, the tubular member opens the fluid passage by moving in a direction that points from the second end to the first end.

8. The valve assembly according to claim 7, wherein
the second anti-cavitation through hole is closer to the first end of the fitting assembly compared to the second outer through hole in the axial direction (L).

9. The valve assembly according to claim 7, wherein
the fitting assembly comprises an anti-cavitation spring, the anti-cavitation spring being constructed such that the tubular member is offset in the direction pointing from the first end to the second end.

10. The valve assembly according to claim 9, wherein
the anti-cavitation spring is a helical spring, the anti-cavitation spring being wound on the radial outer surface of the tubular member and being located between the radial outer surface of the tubular member and the radial inner surface of the sleeve.

11. The valve assembly according to claim 9, wherein
the anti-cavitation spring is a helical spring, and the anti-cavitation spring is arranged on an outer side of the tubular member axial end in the axial direction.

12. The valve assembly according to claim 1, wherein
the first fluid passage is a servo side passage of the fluid device, and the second fluid passage is an oil tank side passage of the fluid device.

13. The valve assembly according to claim 1, wherein
the fluid device is a flow amplifier, and the first outer through hole passes into the servo side passage of the flow amplifier at an outer surface of the fitting assembly, and the second outer through hole passes into the oil tank side passage of the flow amplifier at the outer surface of the fitting assembly.

14. A flow amplifier, wherein the flow amplifier comprises one or more of the valve assemblies according to claim 1.

15. A fluid device, wherein the fluid device comprises one or more of the valve assemblies according to claim 1.
